(19) United States
(12) Patent Application Publication
(10) Pub. No.: US 2014/0337323 A1
(43) Pub. Date: Nov. 13, 2014

(54) METHODS AND COMPUTING SYSTEMS FOR GENERATING AND OPERATING A SEARCHABLE CONSUMER MARKET RESEARCH KNOWLEDGE REPOSITORY

(71) Applicant: New Consumer Solutions LLC, Chicago, IL (US)

(72) Inventors: Andrew Soep, Chicago, IL (US); Kristi Zuhlke-Kimball, Chicago, IL (US); John Hess, Naperville, IL (US)

(21) Appl. No.: 14/273,307

(22) Filed: May 8, 2014

Related U.S. Application Data
(60) Provisional application No. 61/820,783, filed on May 8, 2013.

(51) Int. Cl. G06Q 30/02; G06F 17/30

(52) U.S. Cl. CPC G06Q 30/0201; G06F 17/30091; G06F 17/30554
USPC 707/722

(57) ABSTRACT

Methods and computing systems for generating and operating a searchable consumer market research (CMR) knowledge repository are provided. In one example, a method for generating a searchable CMR knowledge repository includes: (i) obtaining CMR data associated with one or more CMR studies; (ii) classifying the CMR data as at least one of: one or more CMR quantitative data files, one or more CMR summary files, and one or more CMR associated files; and (iii) storing a first portion of the CMR data in a first data storage repository and a second portion of the CMR data in a second data storage repository based on the classification in order to generate the searchable CMR knowledge repository.

### PRIORITY CLAIM

This application claims priority to U.S. provisional patent application No. 61/820,783 entitled Methods and Devices for Generating a Market Research Knowledge Database.

### FIELD

The present technology relates generally to the design of a system for management and analysis of enterprise data, and more particularly, to techniques for designing a comprehensive market research repository and providing for the operation thereof.

### BACKGROUND

Currently, entities (e.g., companies) are not storing market research data in a single, universally accessible location. Rather, in many entities, market research data is stored across several different employees' local workstations. This is known as “silo-ing.” As a result of this effect, individual employees are often restricted to accessing and analyzing the market research data located on their personal workstation and, thus, do not have access to the complete universe of market research data stored across all of the entity's workstations.

Further complicating this issue is the high turnover rate for employees in many industries. Specifically, it has become commonplace for employees to leave a certain job before they have had the opportunity to transfer localized market research data from their personal workstation to a universally accessible data repository.

What is needed, therefore, is a universally accessible market research tool that enables entities to easily store and accesses market research data possessed by a plurality of employees or at a plurality of workstations. The present technology provides this advantage, among many others.

### SUMMARY

The instant disclosure describes techniques and systems for generating and operating a searchable consumer market research (CMR) knowledge repository. To this end, in one example, a computer-implemented method for generating and operating a searchable CMR knowledge repository is provided. The method includes obtaining CMR data associated with one or more CMR studies, classifying the CMR data, storing a first portion of the CMR data in a first data storage repository and a second portion of the CMR data in a second data storage repository based on the classification, obtaining a CMR query, retrieving the CMR search results data based on the CMR query, and outputting at least a portion of the CMR search results data for display. The searchable CMR knowledge repository includes the first data storage repository and the second data storage repository and the CMR data stored in each. The CMR data is classified as one or more CMR quantitative data files, one or more CMR summary files, and/or one or more CMR associated files. The CMR search results are retrieved in response to the CMR query. The CMR query includes a request to search the searchable CMR knowledge repository for CMR search results data related to the query.

In another example, obtaining the CMR data includes receiving, via a client portal, the CMR data and/or retrieving the CMR data by crawling one or more data repositories associated with one or more clients.

In one example, the first portion of the CMR data includes one or more CMR quantitative data files. In this example, storing the first portion of the CMR data in the first data repository includes storing the first portion of the CMR data in a NoSQL database.

In another example, the second portion of the CMR data includes one or more CMR summary files. In this example, storing the second portion of the CMR data in the second data repository includes storing the second portion of the CMR data in an inverted index.

In another example, the method also includes storing a third portion of the CMR data in a third data repository. In this example, the third portion of the CMR data includes the one or more associated files, and the third data repository includes an ephemeral file store.

In one example, the method also includes aggregating any unaggregated data points which are present in the one or more CMR quantitative data files in response to classifying at least a portion of the CMR data as the one or more CMR quantitative data files. This provides aggregated data points associated with the one or more CMR quantitative data files. In this example, the method also includes extracting the aggregated data points associated with the one or more CMR quantitative data files and storing the extracted aggregated data points in at least one of the first and second data storage repositories. The extracted and stored aggregated data points are available for use in outputting at least a portion of the CMR search results data.

In another example, the CMR search results data includes a list of one or more selectable studies relevant to the CMR query. This example may also include obtaining filtering request data. The filtering request data includes data indicating which particular selectable studies should be output for display as part of the CMR search results based on filtering criteria. The filtering request data may also include geography data identifying one or more locations where the one or more selectable studies were conducted, category data identifying one or more topical categories associated with the one or more selectable studies, and/or study-type data identifying one or more study-types associated with the one or more selectable studies.

In one example, where the CMR search results data includes a list of one or more selectable studies relevant to the CMR query, the method may also include obtaining study selection data. In this example, the study selection data includes data identifying a particular study from amongst the list of one or more selectable studies. The method of this example may also include outputting graphical display data in response to obtaining the study selection data. The graphical display data may include a graphical representation of at least a portion of quantitative results associated with the selected study.

In another example, when the method includes outputting graphical display data in response to obtaining the study selection data, the method may also include obtaining graphic-style selection data. The graphic-type selection data includes data identifying a particular graphic-style from amongst a plurality of different graphic styles to be applied to the graphical display data.

In one example, when the method includes outputting graphical display data in response to obtaining the study selection data, the method may also include exporting the graphical display data by generating a .xml file comprising the graphical display data, generating a .pdf file comprising the graphical display data, generating an image file comprising the graphical display data, and/or generating an email comprising the graphical display data.

In another example, when the method includes outputting graphical display data in response to obtaining the study selection data, the method may also include obtaining breakout request data, adjusting the graphical display data based on the breakout request data to provide adjusted graphical display data, and outputting the adjusted graphical display data for display. In this example, the breakout request data includes data indicating which data points of a plurality of available data points should be included as part of the graphical display data.

Related computing systems and computer-readable media for carrying out the aforementioned techniques are also disclosed.

### BRIEF DESCRIPTION OF THE FIGURES

Various features and advantages of this disclosure may be more readily understood with reference to the following detailed description taken in conjunction with the accompanying drawing figures, wherein like reference numerals designate like structural elements, and in which:

FIG. 1 depicts a block diagram schematic of a computing device, in accordance with some embodiments of this disclosure.

FIG. 2 is a block diagram illustrating one example of a computing system for generating a searchable consumer market research knowledge repository in accordance with this disclosure.

FIG. 3 is a block diagram illustrating one example of a computing system for operating a searchable consumer market research knowledge repository in accordance with this disclosure.

FIG. 4 illustrates one example of a graphical user interface displaying consumer market research results data in accordance with this disclosure.

FIG. 5 illustrates one example of the graphical user interface of FIG. 4 wherein geographic filtering has been applied to the consumer market research results data in accordance with this disclosure.

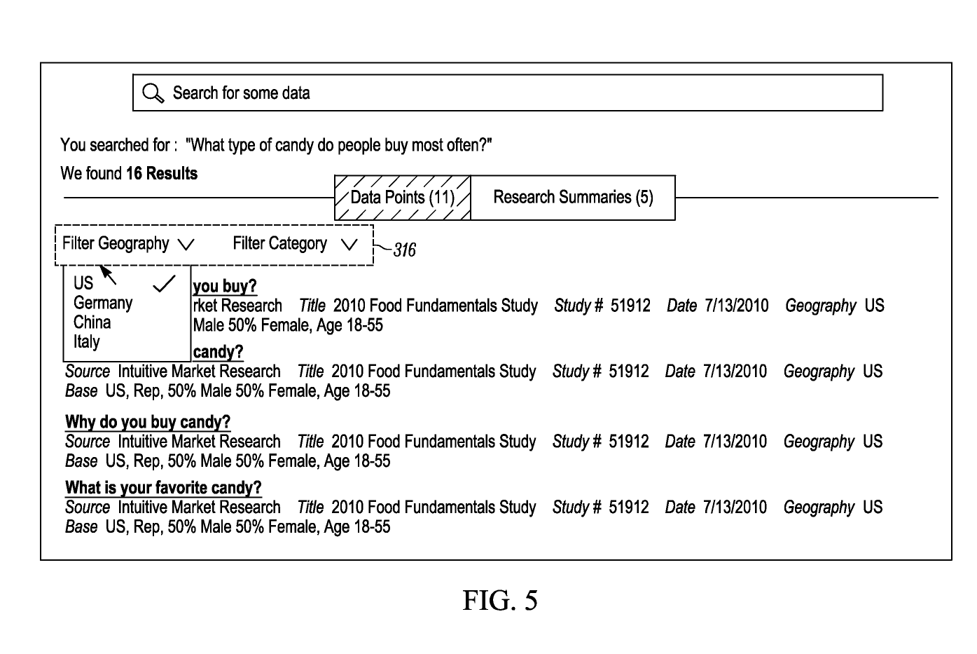

FIG. 6 illustrates one example of a graphical user interface displaying graphical display data in accordance with this disclosure.

FIG. 7 illustrates one example of a graphical user interface displaying different graphical display data than the graphical user interface of FIG. 8 based on graphic-style selection data in accordance with this disclosure.

FIG. 8 illustrates one example of a graphical user interface allowing for the submission of breakout request data in accordance with this disclosure.

FIG. 9 illustrates one example of the graphical user interface of FIG. 8 after some breakout request data has been submitted in accordance with this disclosure.

FIG. 10 illustrates one example of a graphical user interface allowing for the selection of various export options for exporting graphical display data in accordance with this disclosure.

FIG. 11 illustrates one example of a graphical user interface for exporting graphical display data via email in accordance with this disclosure.

FIG. 12 is a flowchart diagram illustrating one example of a method for generating and operating a consumer market research knowledge repository in accordance with this disclosure.

### DETAILED DESCRIPTION

To facilitate an understanding of the principles and features of the various embodiments of the invention, various illustrative embodiments are explained below. Although exemplary embodiments of the invention are explained in detail as being a database tool, it is to be understood that other embodiments are contemplated. Accordingly, it is not intended that the invention is limited in its scope to the details of construction and arrangement of components set forth in the following description or examples. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including” is meant that at least the named compound, element, particle, or method step is, present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

To facilitate an understanding of the principles and features of this disclosure, various illustrative embodiments are explained below. In particular, various embodiments of this disclosure are described as a market research database tool. Some aspects of the invention, however, may be applicable to other contexts, and embodiments employing these aspects are contemplated. Accordingly, where terms such as “market research” or “database” or related terms are used throughout this disclosure, it will be understood that other devices, entities, objects, or activities can take the place of these in various embodiments of the invention.

As described above, a problem that many entities are facing is that the data is not stored in a single, universally accessible location. Instead, data is stored on a plurality of workstations, limiting access to the data. Moreover, this data is frequently stored in several disparate formats, making it extremely difficult to efficiently analyze all of the data in toto. Further still, current database search technologies (e.g., conventional database search engines) do not all users to make intelligent queries (e.g., queries expressed in sentence structure, rather than mere keyword searching) of the database. Accordingly, the present technology provides a database tool, such as a market research database tool, that enables access to data that was originally stored across several disparate workstations. Furthermore, the market research database tool described herein is configured to transform all of the different types of data (i.e., different formats of data) into a single, unified format. In one embodiment, the database tool can be implemented as computing device, such as the computing device described below.

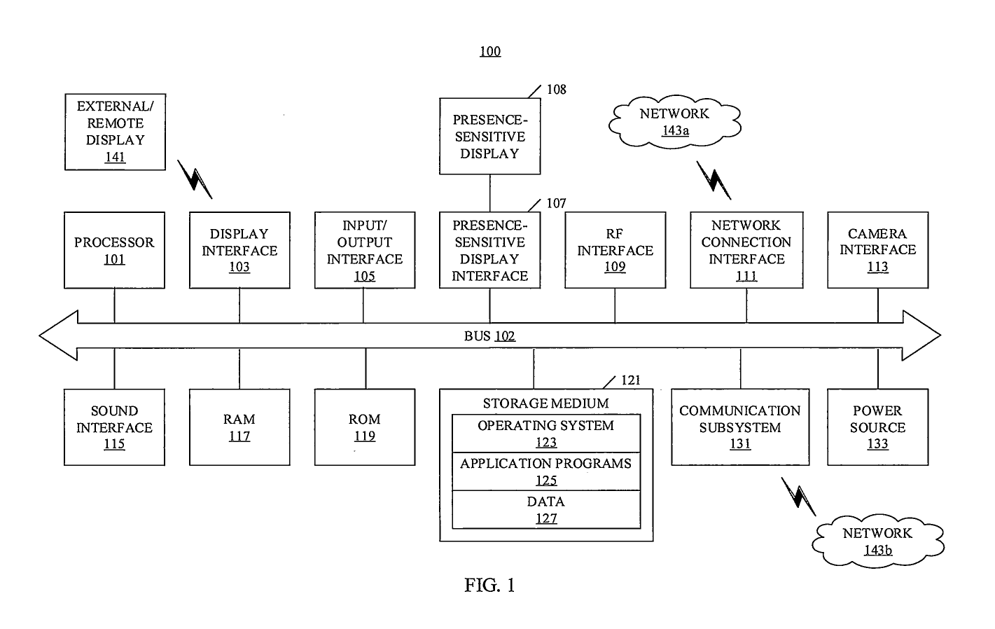

According to one example implementation, the terms computing device or mobile computing device, as used herein, may be a central processing unit (CPU), controller or processor, or may be conceptualized as a CPU, controller or processor (for example, the processor 101 of FIG. 1). In yet other instances, a computing device may be a CPU, controller or processor combined with one or more additional hardware components. In certain example implementations, the computing device operating as a CPU, controller or processor may be operatively coupled with one or more peripheral devices, such as a display, navigation system, stereo, entertainment center, Wi-Fi access point, or the like. In another example implementation, the term computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the computing device may output content to its local display or speaker(s). In another example implementation, the computing device may output content to an external display device (e.g., over Wi-Fi) such as a TV or an external computing system.

FIG. 1 is a block diagram illustrating one embodiment of a computing device 100 in accordance with various aspects set forth herein. In FIG. 1, the computing device 100 may be configured to include a processor 101, which may also be referred to as a computing device, that is operatively coupled to a display interface 103, an input/output interface 105, a presence-sensitive display interface 107, a radio frequency (RF) interface 109, a network connection interface 111, a camera interface 113, a sound interface 115, a random access memory (RAM) 117, a read only memory (ROM) 119, a storage medium 121, an operating system 123, an application program 125, data 127, a communication subsystem 131, a power source 133, another element, or any combination thereof. In FIG. 1, the processor 101 may be configured to process computer instructions and data. The processor 101 may be configured to be a computer processor or a controller. For example, the processor 101 may include two computer processors. In one definition, data is information in a form suitable for use by a computer. It is important to note that a person having ordinary skill in the art will recognize that the subject matter of this disclosure may be implemented using various operating systems or combinations of operating systems.

In FIG. 1, the display interface 103 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia interface (HDMI) port, a video port, an audio port, a Bluetooth port, a near-field communication (NFC) port, another like communication interface, or any combination thereof. In one example, the display interface 103 may be operatively coupled to a local display, such as a touch-screen display associated with a mobile device. In another example, the display interface 103 may be configured to provide video, graphics, images, text, other information, or any combination thereof for an external/remote display 141 that is not necessarily connected to the mobile computing device. In one example, a desktop monitor may be utilized for mirroring or extending graphical information that may be presented on a mobile device. In another example, the display interface 103 may wirelessly communicate, for example, via the network connection interface 111 such as a Wi-Fi transceiver to the external/remote display 141.

In the current embodiment, the input/output interface 105 may be configured to provide a communication interface to an input device, output device, or input and output device. The computing device 100 may be configured to use an output device via the input/output interface 105. A person of ordinary skill will recognize that an output device may use the same type of interface port as an input device. For example, a USB port may be used to provide input to and output from the computing device 100. The output device may be a speaker, a sound card, a video card, a display, a monitor, a printer, an actuator, an emitter, a smartcard, another output device, or any combination thereof. The computing device 100 may be configured to use an input device via the input/output interface 105 to allow a user to capture information into the computing device 100. The input device may include a mouse, a trackball, a directional pad, a trackpad, a presence-sensitive input device, a presence-sensitive display, a scroll wheel, a digital camera, a digital video camera, a web camera, a microphone, a sensor, a smartcard, and the like. The presence-sensitive input device may include a digital camera, a digital video camera, a web camera, a microphone, a sensor, or the like to sense input from a user. The presence-sensitive input device may be combined with a display to form a presence-sensitive display. Further, the presence-sensitive input device may be coupled to the computing device. The sensor may be, for instance, an accelerometer, a gyroscope, a tilt sensor, a force sensor, a magnetometer, an optical sensor, a proximity sensor, another like sensor, or any combination thereof. For example, the input device 115 may be an accelerometer, a magnetometer, a digital camera, a microphone, and an optical sensor.

In FIG. 1, the presence-sensitive display interface 107 may be configured to provide a communication interface to a pointing device or a presence-sensitive display 108 such as a touch screen. In one definition, a presence-sensitive display is an electronic visual display that may detect the presence and location of a touch, gesture, or object near its display area. In one definition, the term “near” means on, proximate or associated with. In another definition, the term “near” is the extended spatial location of. The RF interface 109 may be configured to provide a communication interface to RF components such as a transmitter, a receiver, and an antenna. The network connection interface 111 may be configured to provide a communication interface to a network 143a. The network 143a may encompass wired and wireless communication networks such as a local-area network (LAN), a wide-area network (WAN), a computer network, a wireless network, a telecommunications network, another like network or any combination thereof. For example, the network 143a may be a cellular network, a Wi-Fi network, and a near-field network. As previously discussed, the display interface 103 may be in communication with the network connection interface 111, for example, to provide information for display on a remote display that is operatively coupled to the computing device 100. The camera interface 113 may be configured to provide a communication interface and functions for capturing digital images or video from a camera. The sound interface 115 may be configured to provide a communication interface to a microphone or speaker.

In this embodiment, the RAM 117 may be configured to interface via the bus 102 to the processor 101 to provide storage or caching of data or computer instructions during the execution of software programs such as the operating system, application programs, and device drivers. In one example, the computing device 100 may include at least one hundred and twenty-eight megabytes (128 Mbytes) of RAM. The ROM 119 may be configured to provide computer instructions or data to the processor 101. For example, the ROM 119 may be configured to be invariant low-level system code or data for basic system functions such as basic input and output (I/O), startup, or reception of keystrokes from a keyboard that are stored in a non-volatile memory. The storage medium 121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives. In one example, the storage medium 121 may be configured to include an operating system 123, an application program 125 such as a web browser application, a widget or gadget engine or another application, and a data file 127.

In FIG. 1, the computing device 101 may be configured to communicate with a network 143b using the communication subsystem 131. The network 143a and the network 143b may be the same network or networks or different network or networks. The communication functions of the communication subsystem 131 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 131 may include cellular communication, Wi-Fi communication, Bluetooth communication, and GPS communication. The network 143b may encompass wired and wireless communication networks such as a local-area network (LAN), a wide-area network (WAN), a computer network, a wireless network, a telecommunications network, another like network or any combination thereof. For example, the network 143b may be a cellular network, a Wi-Fi network, and a near-field network. The power source 133 may be configured to provide an alternating current (AC) or direct current (DC) power to components of the computing device 100.

In FIG. 1, the storage medium 121 may be configured to include a number of physical drive units, such as a redundant array of independent disks (RAID), a floppy disk drive, a flash memory, a USB flash drive, an external hard disk drive, thumb drive, pen drive, key drive, a high-density digital versatile disc (HD-DVD) optical disc drive, an internal hard disk drive, a Blu-Ray optical disc drive, a holographic digital data storage (HDDS) optical disc drive, an external mini-dual in-line memory module (DIMM) synchronous dynamic random access memory (SDRAM), an external micro-DIMM SDRAM, a smartcard memory such as a subscriber identity module or a removable user identity (SIM/RUIM) module, other memory, or any combination thereof. The storage medium 121 may allow the computing device 100 to access computer-executable instructions, application programs or the like, stored on transitory or non-transitory memory media, to off-load data, or to upload data. An article of manufacture, such as one utilizing a communication system may be tangibly embodied in storage medium 122, which may comprise a computer-readable medium.

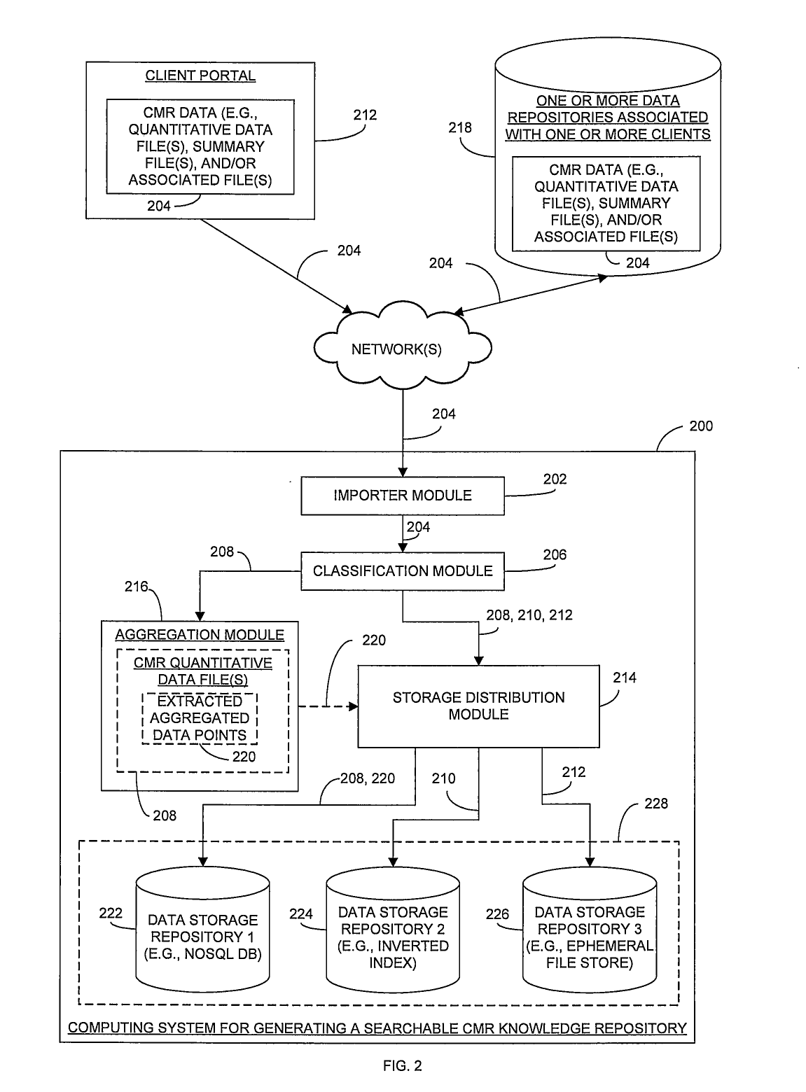

Referring now to FIG. 2 a block diagram illustrating one example of a computing system 200 for generating a searchable consumer market research knowledge repository 228 in accordance with this disclosure is provided. The computing system 200 may include an importer module 202, a classification module 206 operatively connected to the importer module 202, an aggregation module 216 operatively connected to the classification module 206, and a storage distribution module 214 operatively connected to the classification module 206 and the aggregation module 216. In addition, the storage distribution module 214 may be operatively connected to one or more data storage repositories.

In the example shown in FIG. 2, the storage distribution module 214 is operatively connected to three different data storage repositories: data storage repository 1 222, data storage repository 2 224, and data storage repository 3 226. While the instant example illustrates the storage distribution module 214 being operatively connected to three separate data storage repositories, those having ordinary skill in the art will appreciate that aims of the instant disclosure may be achieved through the use of one or more data storage repositories without substantially deviating from the teachings of the instant disclosure. In addition, in the example shown in FIG. 2, the data storage repositories 222, 224, and 226 are shown as part of the computing system 200 for simplicity. However, those having ordinary skill will recognize that any or all of the data repositories 222, 224, 226 do not need to be local to the computing system 200. For example, in some embodiments, one or more of the data storage repositories 222, 224, 226 may be remotely coupled to the storage distribution module 214 via suitable wired (e.g., via one or more buses or the like) or wireless (e.g., via one or more networks) connection.

In accordance with some embodiments of the instant disclosure, the data storage repositories 222, 224, 226 may exhibit structural differences aimed at leveraging the different types of data that may be stored in the data storage repositories 222, 224, 226. For example, in one embodiment, data storage repository 1 222 may comprise a NoSQL database. The advantages of utilizing a NoSQL database structure for data storage repository 1 222 will be evident to those having ordinary skill in the art in light of the type, or types, of data that are contemplated being stored in data storage repository 1 222 in line with the teachings that follow. In addition, in one example, data storage repository 2 224 may comprise an inverted index. As with the preceding discussion concerning data storage repository 1 222, the advantages of utilizing an inverted index structure for data storage repository 2 224 will be evident to those having ordinary skill in the art in light of the type, or types, of data that are contemplated being stored in data storage repository 2 224 in line with the teachings that follow. Further still, in one example, data storage repository 3 226 may comprise an ephemeral file store. The advantages of utilizing an ephemeral file store structure for data storage repository 3 226 will be evident to those having ordinary skill in the art in light of the type, or types, of data that are contemplated being stored in data storage repository 3 226 in line with the teachings that follow.

Computing system 200 may be operatively connected to a client portal 212 and/or one or more data repositories associated with one or more clients 218. As shown, computing system 200 is operatively connected to the client portal 212 and/or the one or more data repositories associated with one or more clients 218 over a wireless network such as the Internet. However, computing system 200 may be suitably connected to the client portal 212 and/or the one or more data repositories associated with one or more clients 218 via other means without deviating from the teachings of the instant disclosure. For example, in some embodiments, the client portal 212 and/or the one or more data repositories associated with one or more clients 218 may be operatively connected to computing system 200 via suitable wired or wireless connections known in the art.

In one exemplary embodiment, client portal 212 may comprise a website hosted on a FTP server or like, whereby clients (e.g., companies/individuals that have consumer market research data that they would like to have analyzed and processed by computing system 200) may upload consumer market research (CMR) data 204 for importation into computing system 200 via importer module 202. Other suitable mechanisms for implementing client portal 212 will be evident to those having ordinary skill in the art and are contemplated within the instant disclosure. In one exemplary embodiment, the one or more data repositories associated with one or more clients 218 may include databases, file stores, and the like hosted on client's enterprise systems. In still another embodiment, the one or more data repositories associated with one or more clients 218 may include client's websites. In effect, the one or more data repositories associated with one or more clients 218 may include any client-source of CMR data 204.

In operation, exemplary computing system 200 functions as follows. Importer module 202 is configured to obtain (e.g., fetch and/or receive) consumer market research (CMR) data 204 from, for example, the client portal 212 and/or the one or more data repositories associated with one or more clients 218. As used herein, CMR data 204 may include, for example: (i) CMR quantitative data files 208; (ii) CMR summary files 210; and/or (iii) CMR associated files 212.

CMR quantitative data files 208 are data files that include quantitative data relating to one or more consumer market research studies. For example, in one embodiment, the CMR quantitative data files 208 may include statistical package for social sciences (SPSS) files. In such an embodiment, each SPSS file may include (i) metadata to identify the file (e.g., the name of the client from whom the file was obtained, the name and/or reference number associated with the study that the file pertains to, an identifier of the file itself (e.g., a file name), etc.) and (ii) one or more of .sav files, .mdd files, and .pkd files. In other embodiments, CMR quantitative data files 208 may include comma separated values (CSV) files and/or extensible markup language (XML) files in addition to, or instead of, the SPSS files discussed above.

CMR summary files 210 are files that summarize the findings of the particular CMR studies to which they pertain. For example, a given CMR summary file may include substantially textual data detailing the high level conclusions of the study to which the CMR summary file pertains. CMR summary files may include, for example, .doc/.docx files, .pdf files, and/or .ppt/.pptx files.

CMR associated files 212 are files that are related to a given study, but that do not necessarily include (i) all of the quantitative data points related to the study and/or (ii) the high level findings of the study. By way of example, CMR associated files 212 may include questionnaires used as part of a study, proposals related to a study, stimuli that respondents to the study interacted with during the study, etc. As with the CMR summary files 210, the CMR associated files 212 typically take the form of .doc/.docx files, .pdf files, and/or .ppt/.pptx files.

In one example, importer module 202 is configured to obtain the CMR data 204 by receiving the CMR data 204 via the client portal 212. In another example, the CMR data 204 may be obtained by retrieving (i.e., fetching) the CMR data 204 from the one or more data repositories associated with the one or more clients 218. In this example, the CMR data 204 may be retrieved through the use of a data crawler bot or the like, using data crawling techniques known to those having ordinary skill in the art.

Following importation, the CMR data 204 may be transmitted from the importer module 202 to the classification module 206. Classification module 206 is configured to classify the CMR data 204 as at least one of (i) CMR quantitative data files 208; (ii) CMR summary files 210; and/or (iii) CMR associated files 212. The classification may be based on, for example, the file type or types of the CMR data 204, analysis of the content of the CMR data 204, or through the use of other suitable data classification techniques known in the art. Classification module 204 may also be configured to generate classification data identifying which type of file a given piece, or set, of the CMR data 204 corresponds to. In some embodiments, this classification data may be furnished to the storage distribution module 214 to affect where particular CMR data 204 files are stored.

In one embodiment, upon a determination by the classification module 206 that the CMR data 204 includes one or more CMR quantitative data files 208, the one or more CMR quantitative data files 208 may be transmitted to the aggregation module 216 for further processing prior to storage in one or more of the data storage repositories 222, 224, 226. The aggregation module 216 may be configured to aggregate any unaggregated data points present in the one or more CMR quantitative data files 208 in order to provide aggregated data points associated with the one or more CMR quantitative data files 208. Additionally, the aggregation module 216 may extract the aggregated data points associated with the one or more CMR quantitative data files 208 to provide extracted aggregated data points 220. A more comprehensive description of the functionality of the aggregation module 216 follows.

From a high level, the aggregation module 216 accepts as input data in one format (e.g., SPSS) and makes that data accessible to humans and other modules in another format. That is, the aggregation module 216 may serve as an application programming interface (API) to the data contained in the one or more CMR quantitative data files 208. Importantly, in the context of the instant disclosure, the aggregation module 216 makes individual data points included within the one or more CMR quantitative data files 208 searchable and visualizable for users of the system described in the instant disclosure.

The aggregation module 216 may accept, via HTTP or other methods known in the art, the one or more CMR quantitative data files 208. For purposes of simplicity, the discussion that follows will focus on an embodiment wherein the one or more CMR quantitative data files 208 are SPSS files, however, those having ordinary skill will recognize that the techniques disclosed herein may be equally applied to CMR quantitative data files 208 that have a different file structure than SPSS files (e.g., .ddf and/or .csv). As noted above, a given SPSS file may include metadata identifying the file, as well as .sav file(s), .mdd files, and/or .pkd files. In one embodiment, the aggregation module 216 processes the input CMR quantitative data files 208 as .sav/.mdd pairs. Because the input CMR quantitative data files 208 do not always include .sav/.mdd pairs, in some embodiments, the aggregation module 216 may perform a conversion. For example, in one embodiment, the aggregation module 216 may convert an input .pkd file to a .sav/.mdd pair. Once the input CMR quantitative data files 208 are in the appropriate format, the aggregation module 216 may be configured to extract a list of questions posed to respondents as part of a study from the .mdd file (MetaData Document) and may store information about the questions. In addition, the aggregation module 216 may extract respondents' responses to the questions from the .sav file. The aggregation module 216 may store the extracted information locally (e.g., in an aggregation module database) or remotely, without deviating from the teachings of the instant disclosure.

Following the preceding processing operations, the input CMR quantitative data files 208 may be annotated by the aggregation module 216. Annotation may include marking each question as a “Normal Question,” “Breakout Question,” or an “Omission.” Annotation may also include adding additional metadata at the file level, for example, noting how respondents were selected for inclusion in the relevant study. In one example, the annotation process may be accomplished automatically by the aggregation module 216 based upon an expert system and/or using a machine learning model that leverages previous annotations as input. After the foregoing processing has been achieved, the aggregation module 216 may pass the processed data to the storage distribution module 214 for storage in one or more of the data storage repositories 222, 224, 226.

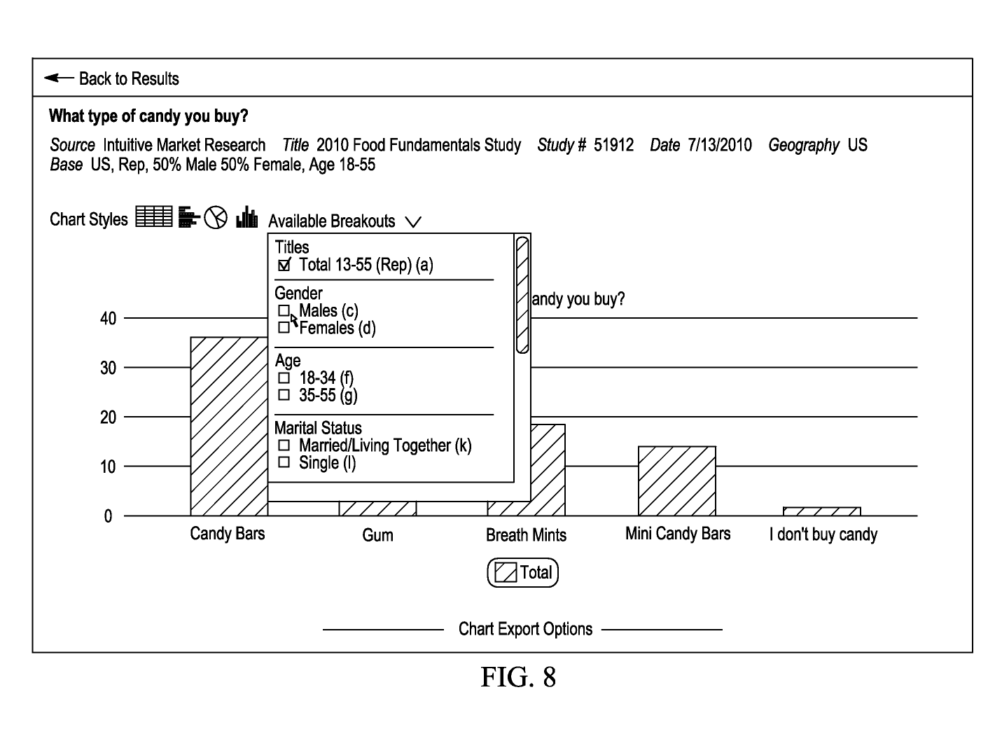

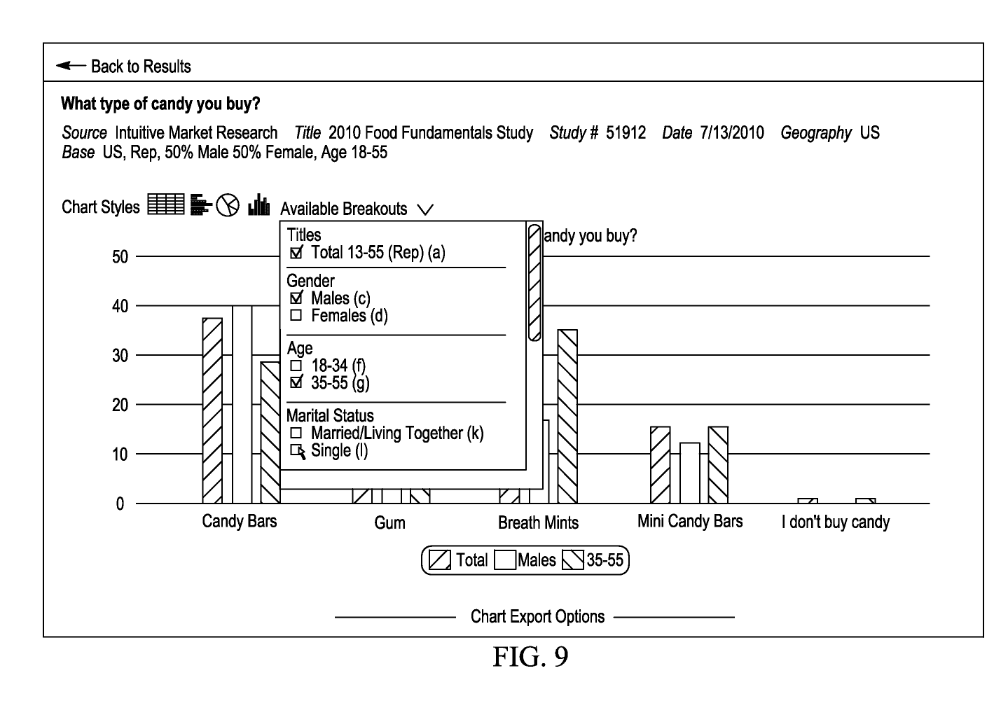

The following example describes one method for aggregating the unaggregated data points included in a given CMR quantitative data file. The input CMR quantitative data file, once parsed in line with the preceding discussion, may be cross-tabulated or “pivoted.” More specifically, each question identified in the study may be pivoted against each “breakout” in line with the following example. A given consumer market research study may ask people about: (Q1) their favorite color; (Q2) their favorite ice cream flavor; and (Q3) the brands of candy bar they often buy. The same study may also collect demographic information about the study respondents: (Q4) age; and (Q4) gender. After the aggregation module 216 parses the files 208 to assess the contents of the files 208 (e.g., a study with five questions and one hundred responses to those questions), in one embodiment, the aggregation module 216 may determine which questions are “breakouts.”Breakouts are discussed in additional detail below with reference to, for example, FIGS. 8-9, however, for the purposes of this example, breakout questions provide information about relevant subsets of the respondents to slice “normal” questions by. In one example, the aggregation module 216 may determine which questions are “breakouts” through the use of a rules engine, artificial intelligence, natural language processing, and/or machine learning techniques known in the art. Continuing with this example, it may be desired to breakout answers by (Q4) age and (Q5) gender. This may be accomplished by the aggregation module 216 through the generation of tables. In this example, breaking out the answers by (Q4) age and (Q5) gender results in the generation of 10 tables. One such table, Q1 broken out by Q5, could look like the following:

TABLE 1

Gender

| Favorite Color | Male | Female |
|---|---|---|
| Red | 20 | 5 |
| Blue | 10 | 5 |
| Green | 30 | 30 |
| Total | 60 | 40 |

However, the above table is merely representative of a given breakout. In practice, the information included in the above table 1 may be stored in a more robust format, such as java script object notation (JSON). Moreover, breakouts need not include demographic information. For example, a given data set could be sliced by other types of information beyond demographic information (e.g., the kind of place that people shop). Continuing with this example, a question and the associated breakout could be “Which kind of store do you normally shop for groceries at: Grocery, Convenience Store, Online Grocer, or Club?” in a situation where it is desirable to know about the preference of club shoppers, for example.

After the aggregation module 216 has performed its processing in line with the above disclosure, it may pass extracted aggregated data points 220 and any other relevant data to the storage distribution module 214. The storage distribution module 214 is configured to store a first portion of the CMR data 204 in a first data repository (e.g., data storage repository 1 222) and a second portion of the CMR data 204 in a second data repository (e.g., data storage repository 2 224) based on the classification of the CMR data 204 via the classification module 206 in order to generate the CMR knowledge repository 228.

In one example, the storage distribution module 214 is configured to store CMR quantitative data files 208, extracted aggregated data points 220, and/or any additional data output from the aggregation module 216 in a NoSQL database (e.g., data storage repository 1 222). In another example, the storage distribution module 214 is configured to store one or more CMR summary files 210 included as part of the CMR data 204 in an inverted index (e.g., data storage repository 2 224). In still another example, the storage distribution module 214 is configured to store one or more associated files 212 in an ephemeral file store (e.g., data storage repository 3 226). The storage of the input CMR data 204 in the one or more data storage repositories 222, 224, 226, in line with the teachings above, results in the generation of the searchable CMR knowledge repository 228.

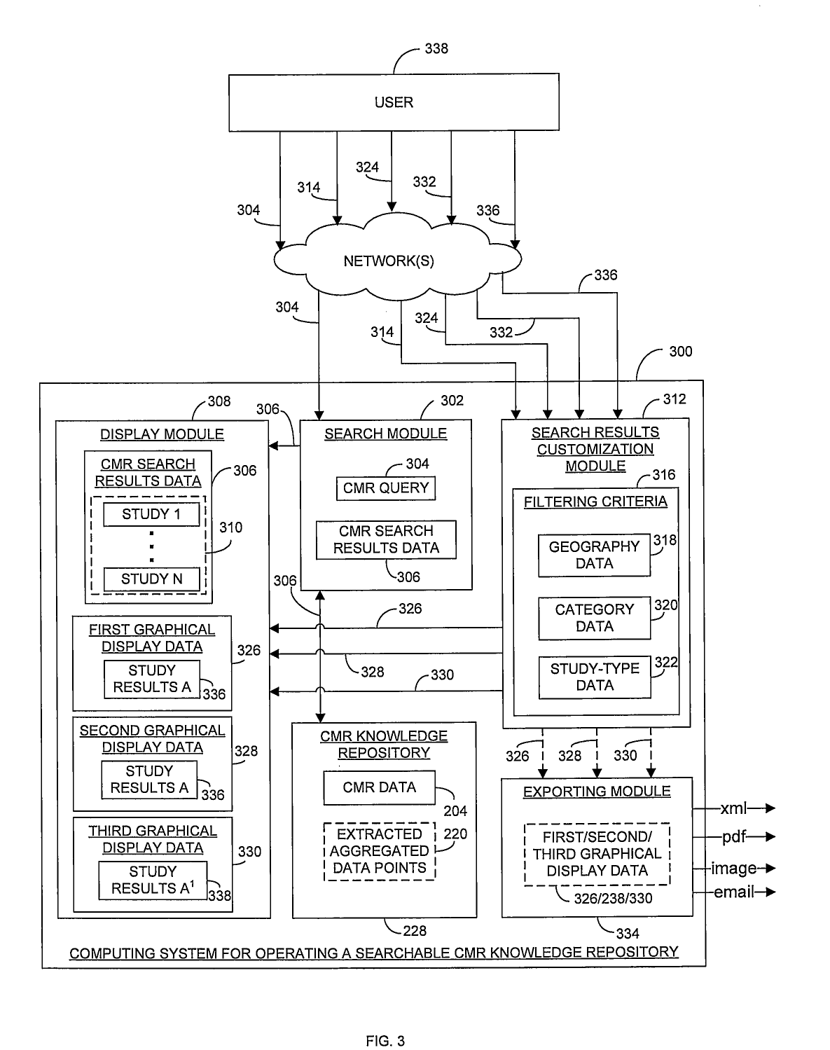

While the operation of the searchable CMR knowledge repository 228 is explained greater detail with regard to FIG. 3 below, the following constitutes a high level exemplary overview of how the CMR data 204 may be leveraged once stored. When a user submits a query requesting CMR data related to the query, the following high level processing may occur. In order to retrieve data points relevant to the query, the system may parse the inverted index to identify and retrieve relevant data (e.g., by utilizing keyword search techniques and the like), and then may parse the NoSQL database to identify and retrieve metadata and data points associated with the relevant studies—this data may be displayed to a user in line with the teachings that follow. In order to retrieve CMR summary files, the system may parse the inverted index to identify and retrieve relevant data (e.g., by utilizing keyword search techniques and the like), and then may parse the NoSQL database to identify and retrieve metadata associated with the CMR summary files—the relevant CMR summary files and their associated metadata may also be presented to a user in line with the teachings that follow. In order to retrieve associated files, the system may parse the NoSQL database to identify relevant metadata, and then may locate and retrieve the associated files from the ephemeral file store based on the metadata from the NoSQL database—the associated files and their associated metadata may also be presented to a user in line with the teachings that follow.

Referring now to FIG. 3, one example of a computing system 300 for operating a searchable CMR knowledge repository 228 in accordance with the instant disclosure is provided. For purposes of simplicity, computing system 300 is shown as being a different computing system than computing system 200 of FIG. 2. However, in one embodiment, computing systems 200 and 300 may be the same computing system. As shown, computing system 300 may include a search module 302, a search results customization module 312, a display module 308, a searchable CMR knowledge repository 228 and an exporting module 334. While shown as being local to computing system 300, those having ordinary skill in the art will recognize that some of the computing system 300 components (e.g., CMR knowledge repository 228) may exist remotely from computing system 300, but may nonetheless operate in accordance with the following discussion via suitable wired or wireless connection to computing system 300.

In addition, computing system 300 is illustrated as being in connection with a user 338 over one or more networks. As with the preceding discussion concerning FIG. 2, in other embodiments, computing system 300 may be in wired or wireless connection with user 338 without deviating from the teachings of the instant disclosure. In addition, in some embodiments, user 338 may include a user operating a user-computing device (e.g., a desktop PD, laptop, smartphone, PDA, cellular phone, tablet, etc.) in order to interact with computing system 300 in the manner described herein.

In operation, computing system 300 functions as follows. A user desirous of leveraging the CMR knowledge repository 228 may issue a CMR query 304 to the search module 302 of computing system 300. A CMR query includes a request to search the searchable CMR knowledge repository 228 for CMR search results data 306 related to the query. An example of a CMR query could include a statement such as “What type of candy do people buy most often?” In response to obtaining the CMR query 304, the search module 302 is configured to retrieve the CMR search results data 306 based on the CMR query 304. The process for retrieving the CMR search results data 306 may be carried out, for example, in line with the above discussion concerning parsing the one or more data storage repositories 222, 224, 226 to identify the CMR search results data 306 relevant to the user's CMR query 304. Once retrieved, the CMR search results data 306 may be shared with one or more of the various computing system components, such as display module 308.

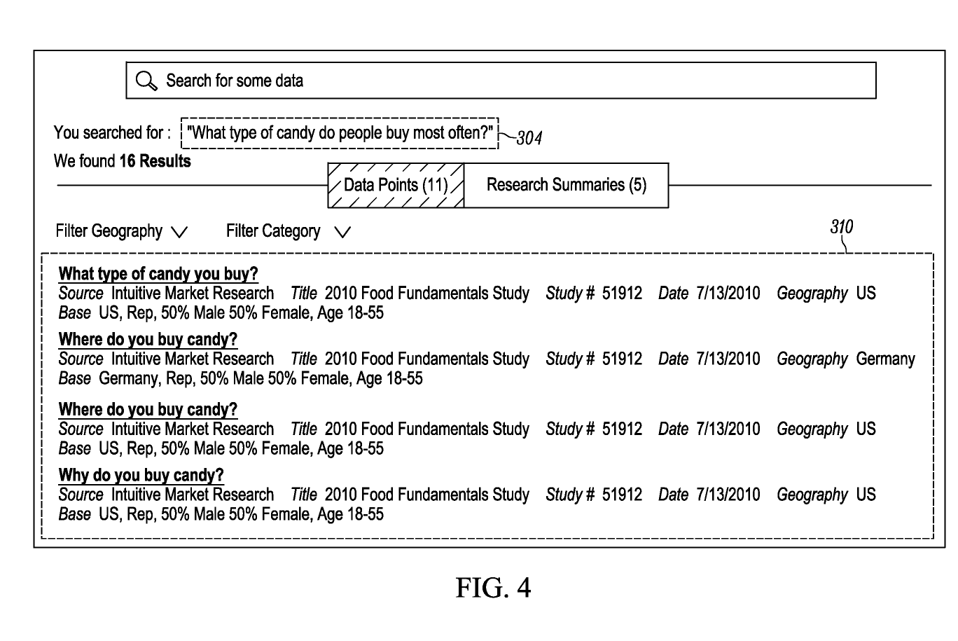

Display module 308 is operatively connected to the search module 302 and is configured to output, for display, at least a portion of the CMR search results data 306. By way of example and not limitation, display module 308 may output at least a portion of the CMR search results data 306 for display on one or more display devices (e.g., Monitors, touchscreens, etc., as known in the art), such as a display device of user's 338 computing device. In one example, the CMR search results data 306 may include a list of one or more selectable studies 310 relevant to the CMR query 304. For example, and with brief reference to FIG. 4, FIG. 4 illustrates one exemplary graphical user interface for displaying at least a portion of the CMR search results data 306 including a list of one or more selectable studies 310 relevant to the CMR query 304.

Search results customization module 312 is operatively connected to the display module 308 and is configured to (i) adjust the CMR search results data 306 based upon user input and (ii) transmit the adjusted CMR search results data to the display module 308 for output, as discussed in more detail below. In one exemplary embodiment, search results customization module 312 is also configured to obtain, from user 338, filtering request data 314. The filtering request data 314 may include data indicating which particular selectable studies should be output for display as part of the CMR search results data 306 based on filtering criteria 316. In one example, the search results customization module 312 may also be configured to filter at least a portion of the CMR search results data 306 based on the filtering criteria 316.

Filtering criteria may include, for example: (i) geography data 318 identifying one or more locations where the one or more selectable studies 310 were conducted (e.g., US, Germany, China, Italy); (ii) category data 320 identifying one or more topical categories associated with the one or more selectable studies 310; and/or (iii) study-type data 322 identifying one or more study-types associated with the one or more selectable studies 310. In some embodiments, category data 320 may be specific to the client from whom the CMR data 204 was obtained. Thus, if the client was a company such as PEPSICO, the category data 320 could include filtering categories such as Natural Beverages, Commercial Beverages, Breakfast, Snacks, Protein, etc. Exemplary study-types could include, but are not limited to, Consumer Satisfaction Research studies, Brand Name Surveys, Test Marketing studies, Concept Testing studies, Segmentation Research studies, etc.

In one example, the search results customization module 312 is further configured to obtain, from user 338, study selection data 324. Study selection data 324 may include data identifying a particular study from amongst the list of one or more selectable studies 310. By way of example and not limitation, a user 338 may provide study selection data 324 by clicking a mouse icon over the name of one of the selectable studies amongst the list 310 through the use of a graphical user interface, such as the graphical user interface shown in FIG. 4. Other means of obtaining study selection data 324 will be apparent to those having ordinary skill in the art.

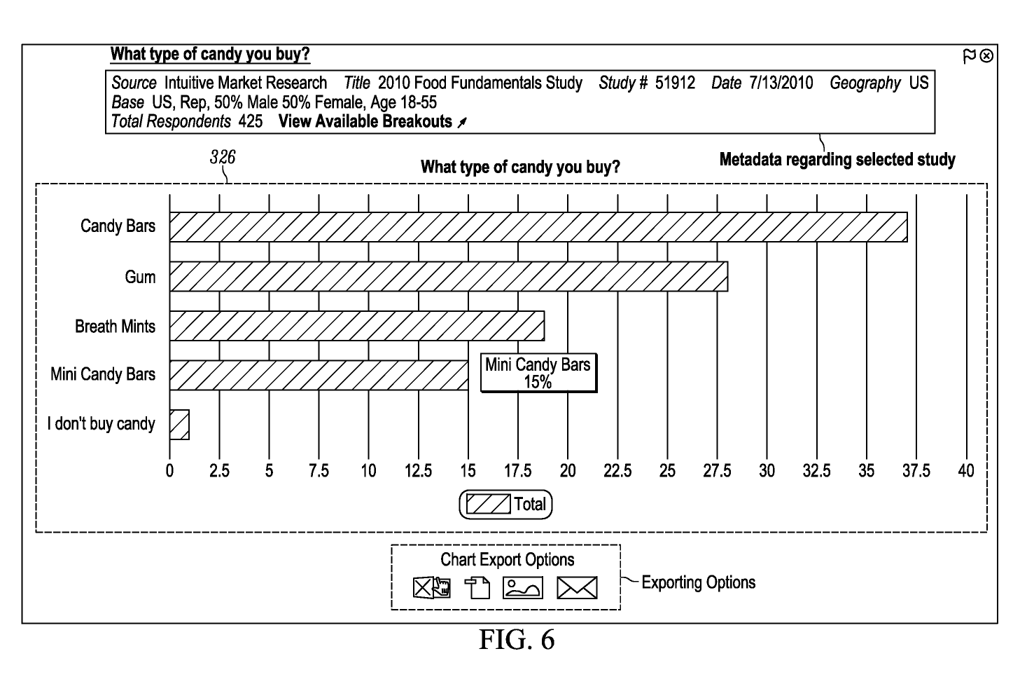

In response to obtaining the study selection data 324, in one example, the search results customization module 312 may generate graphical display data (e.g., first graphical display data 326). The graphical display data may include a graphical representation of at least a portion of quantitative results (e.g., study results A 336) associated with the selected study. For example, and with reference to FIG. 6, FIG. 6 illustrates one example of a graphical user interface including first graphical display data 326 that has been generated based on the study selection data 324 (i.e., a user has selected the study entitled “What type of Candy You Buy?” and the first graphical display data 326 is displayed as part of the GUI based thereon).

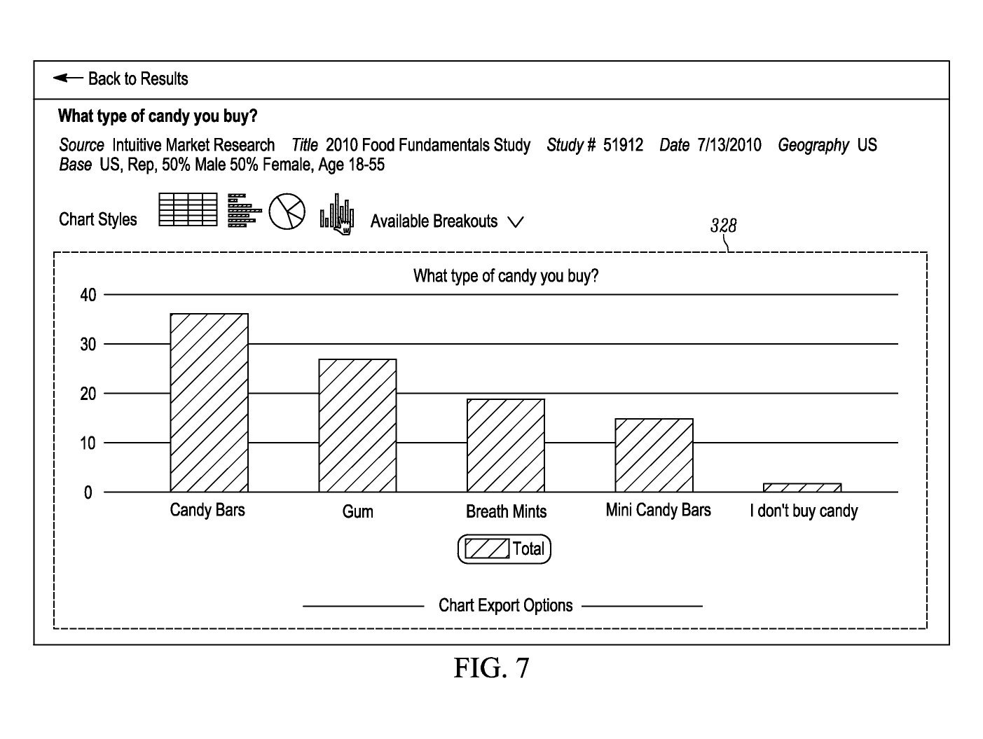

In one embodiment, the search results customization module 312 is also configured to obtain graphic-style selection data 332 (e.g., from user 338). By way of example and not limitation, a user 338 may provide graphic-style selection data 332 by clicking a mouse icon over one or more GUI icons representative of the different, available, graphic-styles, as shown in FIG. 7. Other means of obtaining graphic-style selection data 332 will be apparent to those having ordinary skill in the art. Graphic-style selection data 332 may include data identifying a particular graphic-style from amongst a plurality of different graphic-styles to be applied to the graphical data (e.g., the first graphical display data 326). Different graphic-styles may include, but are not limited to, bar graphs, pie charts, tables, histograms, etc.

In response to obtaining the graphic-style selection data 332, the search results customization module 312 may generate different graphical display data (e.g., second graphical display data 328). The different graphical display data may include a different graphical representation of the same quantitative results associated with the selected study. Thus, in a situation where a user 338 selects a particular study resulting in a GUI displaying a graphical representation of at least a portion of the quantitative results associated with the selected study, a user may then provide graphic-style selection data 332 resulting in the GUI displaying the same portion of the quantitative results associated with the selected study, but in a different format. This functionality is illustrated in the transition from FIG. 6 to FIG. 7, whereby the same quantitative results associated with the study “What Type of Candy you Buy?” are displayed in two different graphical formats.

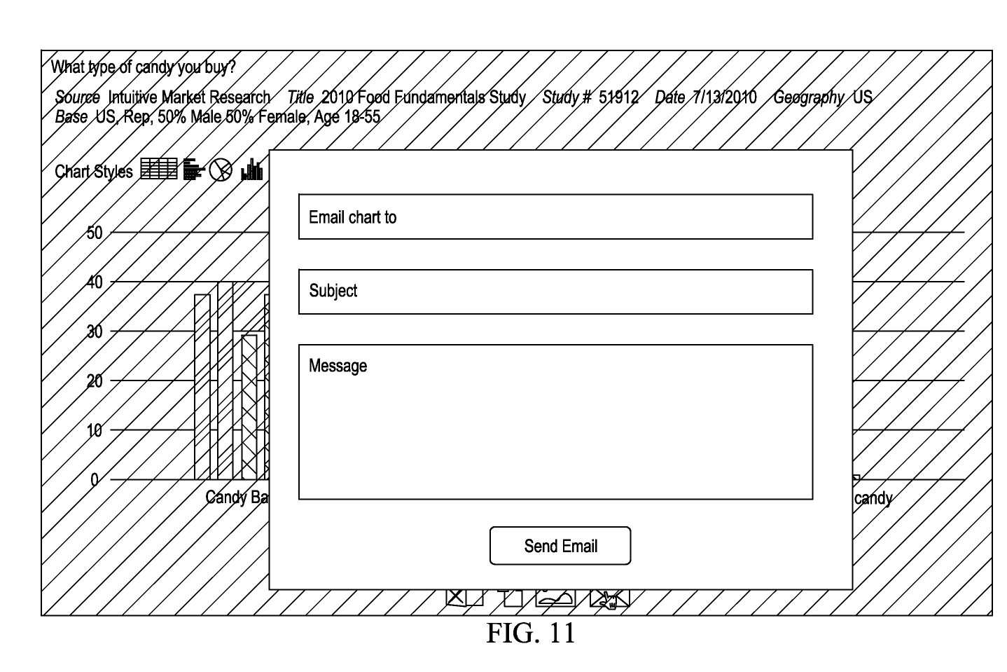

In one example, computing system 300 includes exporting module 334 operatively connected to the search results customization module 312. Exporting module 334 may be configured to export graphical display data related to the selected study in a variety of different formats. By way of example and not limitation, exporting module 334 may export graphical display data (e.g., first 326, second 328, and/or third 330 graphical display data) by: (i) generating a .xml file including the graphical display data; (ii) generating a .pdf file including the graphical display data; (iii) generating an image file (e.g., .gif, .jpeg, .tiff, .png, etc.) including the graphical display data; and/or (iv) generating an email including the graphical display data. By way of example and not limitation, a user 338 may select a particular type of way to export the graphical display data by clicking their mouse over the various export options displayed as part of a GUI, such as the GUI shown in FIG. 6 herein. FIG. 11 herein illustrates one example of a GUI that may be generated in response to a user selecting the email export option.

In one embodiment, the search results customization module 312 is also configured to obtain breakout request data 336 (e.g., from user 338). Breakout request data 336 may include data indicating which data points of a plurality of available data points should be included as part of the graphical display data (e.g., first graphical display data 326). By way of example and not limitation, a user 338 may select various breakout criteria by clicking their mouse over the various available breakout options displayed as part of a GUI, as shown in FIG. 8 herein. For example, and as shown in FIG. 8, only the total responses are provided as part of the graphical display data in this figure. However, as shown in FIG. 9, additional breakout criteria have been selected (i.e., Gender: Males and Age: 35-55). As shown in FIG. 9, the graphical display data has been adjusted (from the graphical display data shown in FIG. 8) such that the new graphical display data (e.g., third graphical display data 330) now includes quantitative measurements (e.g., study results A¹ 338) of (i) how all of the respondents responded to the question at issue; (ii) how males responded to the question at issue; and (iii) how people ages 35-55 have responded to the question at issue.

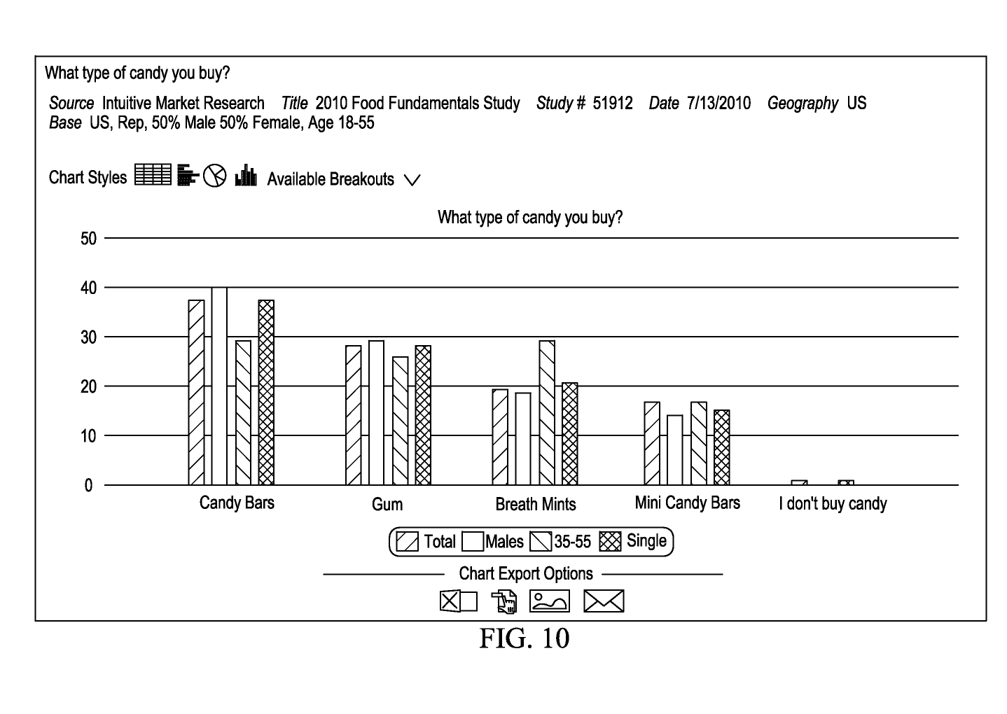

In response to obtaining the breakout request data 336, the search results customization module 312 may generate new graphical display data (e.g., third graphical display data 330) that is different than the graphical display data generated upon the user's selection of the study based on the breakout request data 336. The new graphical display data (e.g., third graphical display data 330) may include a graphical representation of at least a portion of different quantitative results associated with the selected study. This functionality is described above with regard to FIGS. 8-9, and is also illustrated in FIG. 10 (wherein the additional breakout criteria “single” has been selected).

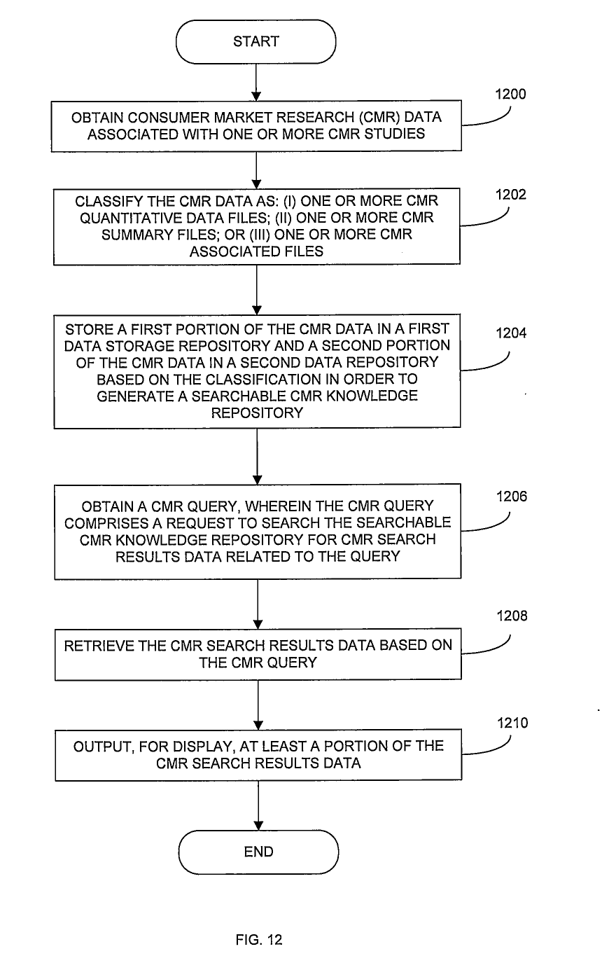

Referring now to FIG. 12, a flowchart illustrating a method for generating and operating a searchable consumer market research knowledge repository is provided. While the computing device 100 is a form for implementing the processing described herein (including that illustrated in FIG. 12), those having ordinary skill in the art will appreciate that other, functionally equivalent techniques may be employed. For example, rather than using a single computing device 100, the functionality described herein may be separated over multiple computing devices. Furthermore, as known in the art, some or all of the functionalities implemented via executable instructions may also be implemented using firmware and/or hardware devices such as application specific integrated circuits (ASICs), programmable logic arrays, state machines, etc. Further still, other implementations of the computing device 100 may include a greater or lesser number of components than those illustrated. Once again, those of ordinary skill in the art will appreciate the wide number of variations that may be used is this manner.

Beginning at block 1200, CMR data associated with one or more consumer market research studies is obtained. At block 1202, the CMR data is classified as: one or more CMR quantitative data files, one or more CMR summary files, and/or one or more CMR associated files. At block 1204, a first portion of the CMR data is stored in a first data storage repository and a second portion of the CMR data is stored in a second data storage repository based on the classification in order to generate the searchable CMR knowledge repository. At block 1206, a CMR query is obtained. The CMR query may include a request to search the searchable CMR knowledge repository for CMR search results data related to the CMR query. At block 1208, CMR search results data is retrieved based on the CMR query. Finally, at block 1210, at least a portion of the CMR search results data is output for display.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for generating and operating a searchable consumer market research (CMR) knowledge repository, the method comprising:
obtaining, by a processing device, CMR data associated with one or more CMR studies;
classifying, by the processing device, the CMR data as at least one of one or more CMR quantitative data files, one or more CMR summary files, and one or more CMR associated files;
storing, by the processing device, a first portion of the CMR data in a first data storage repository and a second portion of the CMR data in a second data storage repository based on the classification in order to generate the searchable CMR knowledge repository;
obtaining a CMR query, wherein the CMR query comprises a request to search the searchable CMR knowledge repository for CMR search results data related to the query;
in response to obtaining the CMR query, retrieving, by the processing device, the CMR search results data based on the CMR query; and
outputting, for display, at least a portion of the CMR search results data.

2. The computer-implemented method of claim 1, wherein obtaining the CMR data comprises at least one of:
receiving, via a client portal, the CMR data; and
retrieving, by the processing device, the CMR data by crawling one or more data repositories associated with one or more clients.

3. The computer-implemented method of claim 1, wherein the first portion of the CMR data comprises the one or more CMR quantitative data files, and wherein storing the first portion of the CMR data in the first data repository comprises storing the first portion of the CMR data in a NoSQL database.

4. The computer-implemented method of claim 1, wherein the second portion of the CMR data comprises the one or more CMR summary files, and wherein storing the second portion of the CMR data in the second data repository comprises storing the second portion of the CMR data in an inverted index.

5. The computer-implemented method of claim 1, further comprising:
storing a third portion of the CMR data in a third data repository, wherein the third portion of the CMR data comprises the one or more associated files, and wherein the third data repository comprises an ephemeral file store.

6. The computer-implemented method of claim 1, further comprising:
in response to classifying at least a portion of the CMR data as the one or more CMR quantitative data files, aggregating any unaggregated data points present in the one or more CMR quantitative data files to provide aggregated data points associated with the one or more CMR quantitative data files;
extracting the aggregated data points associated with the one or more CMR quantitative data files; and
storing the extracted aggregated data points in at least one of the first and second data storage repositories for use in outputting the at least a portion of the CMR search results data.

7. The computer-implemented method of claim 1, wherein the CMR search results data comprises a list of one or more selectable studies relevant to the CMR query.

8. The computer-implemented method of claim 7, further comprising:
obtaining, by the processing device, filtering request data, wherein the filtering request data comprises data indicating which particular selectable studies should be output for display as part of the CMR search results based on filtering criteria.

9. The computer-implemented method of claim 8, wherein the filtering criteria comprises at least one of:
geography data identifying one or more locations where the one or more selectable studies were conducted;
category data identifying one or more topical categories associated with the one or more selectable studies; and
study-type data identifying one or more study-types associated with the one or more selectable studies.

10. The computer-implemented method of claim 7, further comprising:
obtaining, by the processing device, study selection data, wherein the study selection data comprises data identifying a particular study from amongst the list of one or more selectable studies.

11. The computer-implemented method of claim 10, further comprising:
in response to obtaining the study selection data, outputting, for display, graphical display data, wherein the graphical display data comprises a graphical representation of at least a portion of quantitative results associated with the selected study.

12. The computer-implemented method of claim 11, further comprising:
obtaining, by the processing device, graphic-style selection data, wherein the graphic-type selection data comprises data identifying a particular graphic-style from amongst a plurality of different graphic styles to be applied to the graphical display data.

13. The computer-implemented method of claim 11, further comprising:
exporting the graphical display data, wherein exporting the graphical display data comprises at least one of:
generating a .xml file comprising the graphical display data;
generating a .pdf file comprising the graphical display data;
generating an image file comprising the graphical display data; and
generating an email comprising the graphical display data.

14. The computer-implemented method of claim 11, further comprising:
obtaining, by the processing device, breakout request data, wherein the breakout request data comprises data indicating which data points of a plurality of available data points should be included as part of the graphical display data; and
adjusting, by the processing device, the graphical display data based on the breakout request data to provide adjusted graphical display data; and
outputting, for display, the adjusted graphical display data.

15. A computing system for generating and operating a searchable consumer market research (CMR) knowledge repository, the computing system comprising:
an importer module configured to obtain CMR data associated with one or more CMR studies;
a classification module operatively connected to the importer module, the classification module configured to classify the CMR data as at least one of one or more CMR quantitative data files, one or more CMR summary files, and one or more CMR associated files;
a storage distribution module operatively connected to the classification module, the storage distribution module configured to store a first portion of the CMR data in a first data storage repository and a second portion of the CMR data in a second data storage repository based on the classification in order to generate the searchable CMR knowledge repository;
a search module, the search module configured to:
obtain a CMR query, wherein a CMR query comprises a request to search the searchable CMR knowledge repository for CMR search results data related to the query; and
in response to obtaining the CMR query, retrieve the CMR search results data based on the CMR query; and
a display module operatively connected to the search module, the display module configured to output, for display, at least a portion of the CMR search results data.

16. The computing system of claim 15, wherein the importer module is configured to obtain the CMR data associated with the one or more CMR studies by:
receiving, via a client portal, the CMR data; and
retrieving the CMR data by crawling one or more data repositories associated with one or more clients.

17. The computing system of claim 15, wherein the first portion of the CMR data comprises the one or more CMR quantitative data files, and wherein the storage distribution module is configured to store the first portion of the CMR data in the first data repository by storing the first portion of the CMR data in a NoSQL database.

18. The computing system of claim 15, wherein the second portion of the CMR data comprises the one or more CMR summary files, and wherein the storage distribution module is configured to store the second portion of the CMR data in the second data repository by storing the second portion of the CMR data in an inverted index.

19. The computing system of claim 15, wherein the storage distribution module is further configured to store a third portion of the CMR data in a third data repository, wherein the third portion of the CMR data comprises the one or more associated files, and wherein the third data repository comprises an ephemeral file store.

20. The computing system of claim 15, further comprising:
an aggregation module operatively connected to the classification module and the storage distribution module, wherein the aggregation module is configured to:
in response to at least a portion of the CMR data being classified as the one or more CMR quantitative data files, aggregate any unaggregated data points present in the one or more CMR quantitative data files to provide aggregated data points associated with the one or more CMR quantitative data files; and
extract the aggregated data points associated with the one or more CMR quantitative data files to provide extracted aggregated data points.

21. The computing system of claim 20, wherein the storage distribution module is further configured to:
obtain the extracted aggregated data points associated with the one or more CMR quantitative data files from the aggregation module; and
store the extracted aggregated data points in at least one of the first and second data storage repositories for use in outputting the at least a portion of the CMR search results data.

24. The computing system of claim 15, wherein the CMR search results data comprises a list of one or more selectable studies relevant to the CMR query.

25. The computing system of claim 22, further comprising:
a search results customization module operatively connected to the display module, the search results customization module configured to adjust the CMR search results data based upon user input and transmit the adjusted CMR search results to the display module for output.

24. The computing system of claim 23, wherein the search results customization module is further configured to:
obtain, from a user, filtering request data, wherein the filtering request data comprises data indicating which particular selectable studies should be output for display as part of the CMR search results data based on filtering criteria; and
filter the at least a portion of the CMR search results data based on the filtering criteria.

25. The computing system of claim 24, wherein the filtering criteria comprises at least one of:
geography data identifying one or more locations where the one or more selectable studies were conducted;
category data identifying one or more topical categories associated with the one or more selectable studies; and
study-type data identifying one or more study-types associated with the one or more selectable studies.

26. The computing system of claim 23, wherein the search results customization module is further configured to:
obtain, from a user, study selection data, wherein the study selection data comprises data identifying a particular study from amongst the list of one or more selectable studies; and
in response to obtaining the study selection data, generating first graphical display data, wherein the first graphical display data comprises a graphical representation of at least a portion of quantitative results associated with the particular study.

27. The computing system of claim 26, wherein the search results customization module is further configured to:
obtain graphic-style selection data, wherein the graphic-type selection data comprises data identifying a particular graphic-style from amongst a plurality of different graphic styles to be applied to the first graphical display data; and
in response to obtaining the graphic-style selection data, generating second graphical display data that is different than the first graphical display data, wherein the second graphical display data comprises a different graphical representation of the same quantitative results associated with the same particular study.

28. The computing system of claim 26, further comprising:
an exporting module operatively connected to the search results customization module, wherein the exporting module is configured to export the first graphical display data by performing at least one of the following:
generating a .xml file comprising the first graphical display data;
generating a .pdf file comprising the first graphical display data;
generating an image file comprising the first graphical display data; and
generating an email comprising the first graphical display data.

29. The computing system of claim 26, wherein the search results customization module is further configured to:
obtain breakout request data, wherein the breakout request data comprises data indicating which data points of a plurality of available data points should be included as part of the first graphical display data; and
in response to obtaining the breakout request data, generating third graphical display data that is different than the first graphical display data based on the breakout request data, wherein the third graphical display data comprises a graphical representation of at least a portion of different quantitative results associated with the particular study.

30. A non-transitory computer-readable medium comprising executable instructions that when executed by a processing device cause the processing device to carry out a method comprising:
obtaining CMR data associated with one or more CMR studies;
classifying the CMR data as at least one of: one or more CMR quantitative data files, one or more CMR summary files, and one or more CMR associated files;
storing a first portion of the CMR data in a first data storage repository and a second portion of the CMR data in a second data storage repository based on the classification in order to generate the searchable CMR knowledge repository;
obtaining a CMR query, wherein the CMR query comprises a request to search the searchable CMR knowledge repository for CMR search results related to the query;
in response to obtaining the CMR query, retrieving the CMR search results data based on the CMR query; and
outputting, for display, at least a portion of the CMR search results data.
